(19) United States
(12) Patent Application Publication
(10) Pub. No.: US 2014/0337734 A1
(43) Pub. Date: Nov. 13, 2014

(54) CONTENT MANAGEMENT SYSTEM FOR A 3D VIRTUAL WORLD

(71) Applicants: Linda Bradford, Provo, UT (US); Abraham L. Day, Highland, UT (US); Daniel Campbell, Highland, UT (US)

(72) Inventors: Linda Bradford, Provo, UT (US); Abraham L. Day, Highland, UT (US); Daniel Campbell, Highland, UT (US)

(21) Appl. No.: 13/891,121

(22) Filed: May 9, 2013

(51) Int. Cl. G06F 3/0481

(52) U.S. Cl. CPC G06F 3/04815
USPC 715/719

(57) ABSTRACT

The present invention is a content management system (“CMS”) for a 3D virtual world. In one or more embodiments, the CMS provides user interfaces that allow an instructor to create a course, add pre-programmed 3D scenes to the course, upload slideshow presentations, images, and/or videos (“content”) to the CMS, assemble the content into a presentation, and display the presentation on pre-programmed display areas (“VIEWBoards™”) within a 3D scene. In one or more embodiments, the CMS stores data representing courses created using the user interfaces provided by the CMS in one or more databases. In one or more embodiments, the CMS converts uploaded content into a set of standard image and video formats for display in the 3D scene and stores them in a database.

### BACKGROUND OF THE INVENTION

(1) Field of the Invention

The present invention relates to a content management system that allows a user to create, customize, and control the presentation of audiovisual information in a virtual three-dimensional environment.

(2) Background of the Invention

Three-dimensional (3D) virtual reality technology allows people to explore an environment from a computer system. Some 3D environments duplicate locations in the physical world, allowing a person to explore a real-world place without the time and money expenditure required by physical travel. Other 3D environments depict fictional locations that are impossible to visit in the real world. A person may visit a virtual 3D environment for leisure, entertainment, education, or to conduct business, among many other possibilities. Consequently, various types of virtual 3D worlds have been developed for these purposes.

Prior art virtual 3D environments include multiplayer online role-playing games, such as World of Warcraft, and more general 3D environments, like Second Life. In these environments, users can interact with each other, and in the case of Second Life, can create and display content to other users.

Prior art virtual 3D environments can be difficult to use for educational purposes because they may be equally accessible to every user of the 3D world. Thus, while an instructor can teach a class in a virtual 3D environment, the prior art does not allow the instructor to easily restrict access to a group of students enrolled in the class. In addition, prior art does not offer the instructor the ability to configure unique groupings or instances of 3D environments in real time. Further, creating, uploading, and displaying audiovisual content can require a great degree of technical knowledge with prior art technologies. Therefore, there is a need for a system for managing content in a 3D environment that provides easy-to-use facilities for restricting access to content to particular users (e.g. a group of students enrolled in a class), configuring unique groupings of 3D environments in real-time, and creating and displaying audiovisual content as part of teaching an educational course in a virtual 3D environment and for other purposes.

### BRIEF SUMMARY OF THE INVENTION

The present invention is a content management system (“CMS”) for a 3D virtual world. In one or more embodiments, the CMS provides user interfaces that allow an instructor to create a course, add pre-programmed 3D scenes to the course, upload slideshow presentations, images, and/or videos (“content”) to the CMS, assemble the content into a presentation, and display the presentation on pre-programmed display areas (“VIEWBoards™”) within a 3D scene. In one or more embodiments, the CMS stores data representing courses created using the user interfaces provided by the CMS in one or more databases. In one or more embodiments, the CMS converts uploaded content into a set of standard image and video formats for display in the 3D scene and stores them in a database. In one or more embodiments, the user interfaces provided by the CMS allow an instructor to create sections within each course, where each section is a group of students who are taking the class. In one or more embodiments, the CMS provides user interfaces that allow an instructor to invite students to or remove students from each section. In one or more embodiments, the instructor can delete sections or entire courses from the CMS database using user interfaces provided by the CMS. In one or more embodiments, the CMS provides user interfaces that allow an instructor to rearrange or remove 3D scenes in each course. In one or more embodiments, CMS provides user interfaces that allow an instructor to add, delete, and/or rearrange the images in a presentation. In one or more embodiments, CMS provides user interfaces that allow an instructor to associate annotations or notes with a presentation. In one or more embodiments, CMS provides user interfaces that allow an instructor to designate synchronous or asynchronous use of multimedia content by students.

### BRIEF DESCRIPTION OF THE DRAWINGS

The present invention may be understood and its features made apparent to those skilled in the art by referencing the accompanying drawings.

FIG. 1 shows a login user interface provided by an embodiment of the invention.

FIG. 2 shows a mode selection user interface provided by an embodiment of the invention.

FIG. 3 shows a course management user interface provided by an embodiment of the invention

FIG. 4 shows a first view of an add course user interface provided by an embodiment of the invention.

FIG. 5 shows a second view of an add course user interface provided by an embodiment of the invention.

FIG. 6 shows an edit course user interface provided by an embodiment of the invention.

FIG. 7 shows a section user interface provided by an embodiment of the invention.

FIG. 8 shows an import students user interface provided by an embodiment of the invention.

FIG. 9 shows a first view of a VIEWBoard™ editing user interface provided by an embodiment of the invention.

FIG. 10 shows a second view of a VIEWBoard™ editing user interface provided by an embodiment of the invention.

FIG. 11 shows a new presentation user interface provided by an embodiment of the invention.

FIG. 12 shows a presentation editing user interface provided by an embodiment of the invention.

FIG. 13 shows an image preview user interface provided by an embodiment of the invention.

FIG. 14 shows a first view of an upload user interface provided by an embodiment of the invention.

FIG. 15 shows a second view of an upload user interface provided by an embodiment of the invention.

FIG. 16 shows a user profile user interface provided by an embodiment of the invention.

FIG. 17 shows an edit user user interface provided by an embodiment of the invention.

FIG. 18 illustrates a method used by an embodiment of the invention for uploading, converting, and storing an image or video file in the CMS database.

### DETAILED DESCRIPTION OF THE INVENTION

In the following description, numerous specific details are set forth to provide a more thorough description of the present invention. It will be apparent to one skilled in the art, however, that the present invention may be practiced without those specific details. In other instances, well-known features have not been described in detail so as not to unnecessarily obscure the invention.

In one or more embodiments, the present invention is a content management system (“CMS”) implemented by a server computer system that provides user interfaces that allow a user to upload and manage content for use with a 3-D virtual environment. In one or more embodiments, the present invention provides user interfaces allowing an instructor to configure unique groupings of 3D environments in real-time and to designate synchronous or asynchronous use of multimedia content by students. In one or more embodiments, the user interfaces provided by the CMS are provided as web pages or in another form suitable for display by an internet browser running on a user internet access device, such as a computer, tablet, smartphone, or other internet capable device. In one or more embodiments, the CMS of the invention is configured to interact with a 3-D virtual environment provided by a server system, which may be the same server system that is also providing the CMS, or a different server system or systems. In one or more embodiments, the CMS of the invention is configured to interact with a 3-D virtual environment provided by one or more server systems running the Unity™ game engine. Information about the Unity game engine can be found at http://unity3d.com.

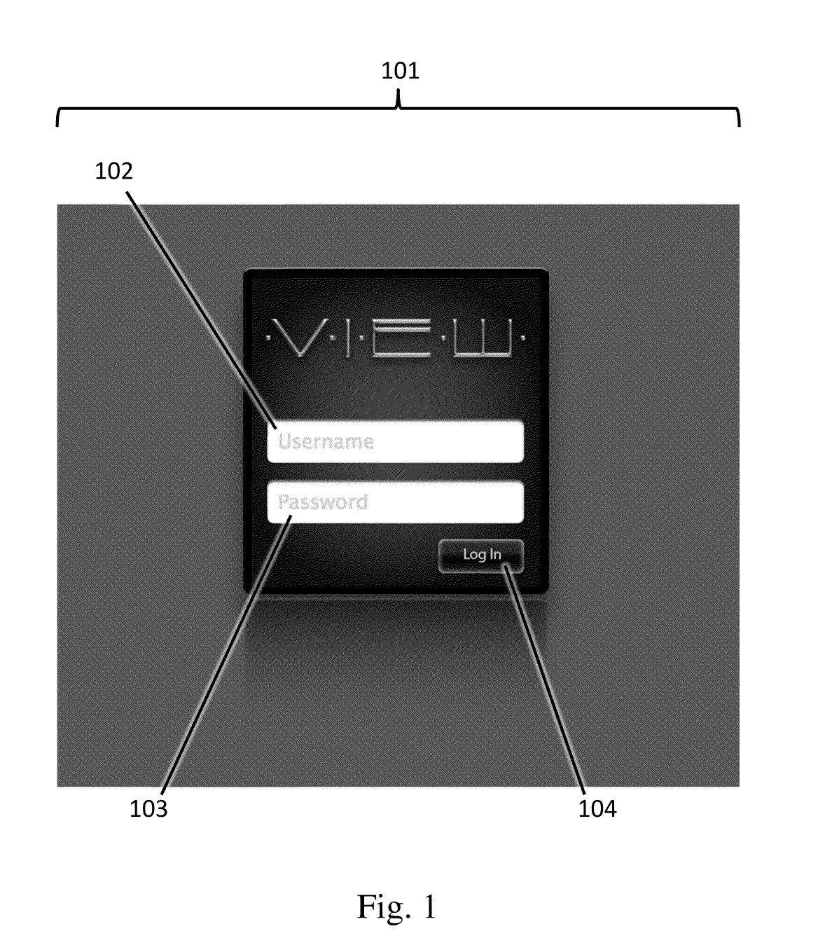

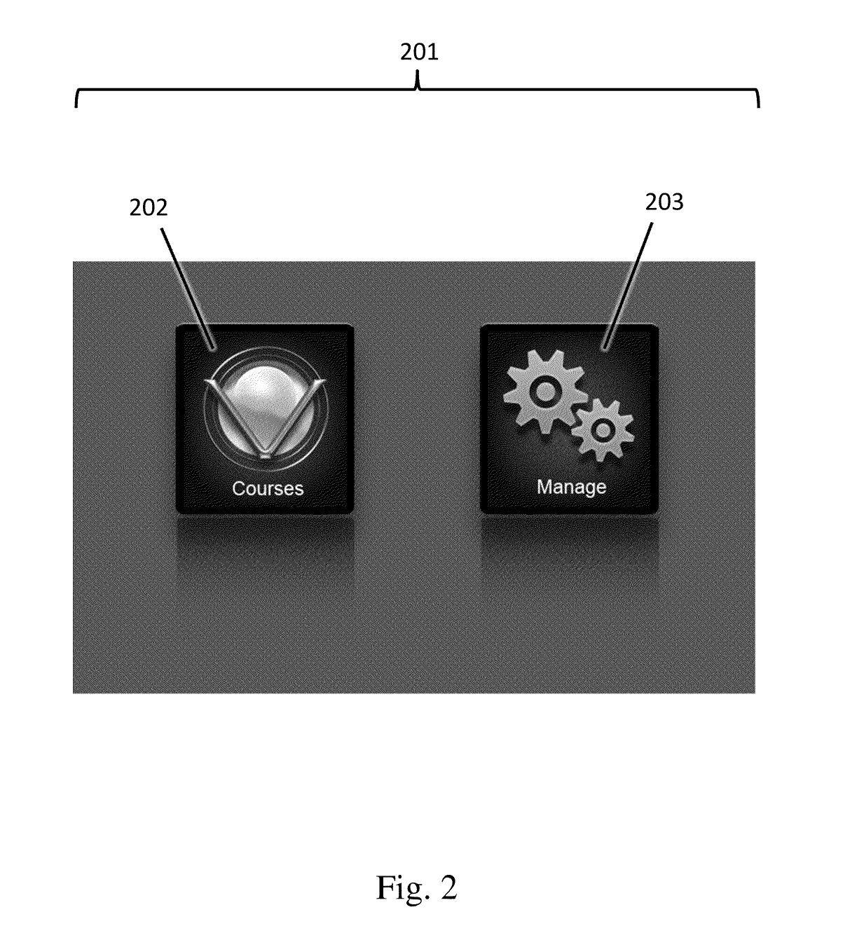

FIG. 1 is a login user interface 101 in the form of a webpage provided by one or more embodiments of the content management system (“CMS”) of the present invention. Login user interface, like the other user interfaces provided by the CMS of the invention, may be displayed by a browser program running on a user's computer. In the embodiment of FIG. 1, login user interface 101 provides text entry field 102 for receiving a username and text entry field 103 for receiving a password. In the embodiment of FIG. 1, login user interface 101 provides a Log In control button 104 that, upon activation, causes the username and password text entered into text entry fields 102 and 103 to be transmitted by the user's browser to the CMS. In one or more embodiments, the CMS checks that the entered username and password combination match a username and password combination stored in a database. In one or more embodiments, if there is a username and password match, the CMS records the username in the database and presents the user interface shown in FIG. 2 to the user.

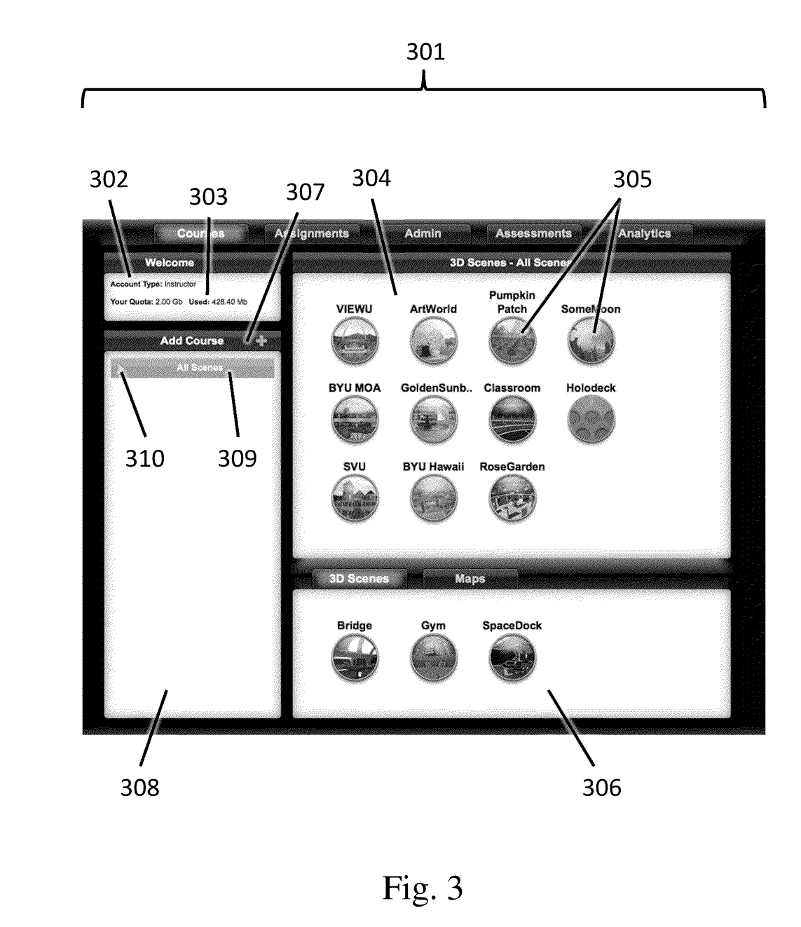

FIG. 2 is a mode selection user interface 201 that the CMS transmits to the user's computer or other internet access device in one or more embodiments of the invention. In the embodiment of FIG. 2, mode selection user interface 201 provides a Courses control button 202 and a Manage control button 203. In the embodiment of FIG. 2, activation of the Courses control button 202 causes a user's browser to issue an appropriate command for accessing the 3D virtual world for which the CMS provides content management services (for example a 3D virtual world served by one or more Unity server systems) so that the user may teach courses, view courses, or interact with other users of the 3D virtual world. In the embodiment of FIG. 2, activation of the Manage control button 203 causes the CMS to provide the user interface shown in FIG. 3 to the user's computer or other internet access device.

FIG. 3 is the course management user interface 301 that the CMS transmits to the user's computer or other internet access device in one or more embodiments of the invention. In the embodiment of FIG. 3, course management user interface 301 displays account type information 302, storage usage information 303, in-use 3D scenes display area 304, available 3D scenes display area 306, Add Course control button 307, list of courses 308, and zero or more course selection controls 309. In the embodiment of FIG. 3, account type information 302 displays data from the CMS database including the type of account the user has, e.g. Instructor, Student, or Administrator. In one or more embodiments, the CMS assigns each user account an account type. In one or more embodiments, the user's account type determines the functionality that the CMS provides to the user. For example, in one or more embodiments, if the account type is an Instructor account, the CMS may provide user interfaces that a user can use to create courses and sections, upload content, create and organize presentations, and display presentations in the 3D virtual world. In one or more embodiments, if the account type is a Student account, the CMS does not provide user interfaces for creating courses or sections, but may provide user interfaces for uploading content, creating and organizing presentations, and with the instructor's permission, displaying presentations in the 3D virtual world. In one or more embodiments, if the account type is an Administrator account, the CMS may provide user interfaces for creating, deleting, or changing other user accounts, assigning instructors or students to courses, or changing institutional information, e.g. the name of an educational institution stored in the CMS database with which a course is affiliated. In one or more embodiments, the CMS may offer other features and functionality for other account types.

In the embodiment of FIG. 3, storage usage information 303 displays the amount of storage space consumed by the user's uploaded content, and the account's storage space quota, if a quota is assigned. In one or more embodiments, the CMS assigns each user account its own quota. In one or more embodiments, the CMS tracks the total amount of data the user has stored and stores that number in a database. In one or more embodiments, if the amount of stored data for the user account exceeds the assigned quota amount, the CMS will not allow the user to upload more data. In one or more embodiments, the CMS provides an interface for the user to delete stored data to reduce the amount of storage space in use to below the quota.

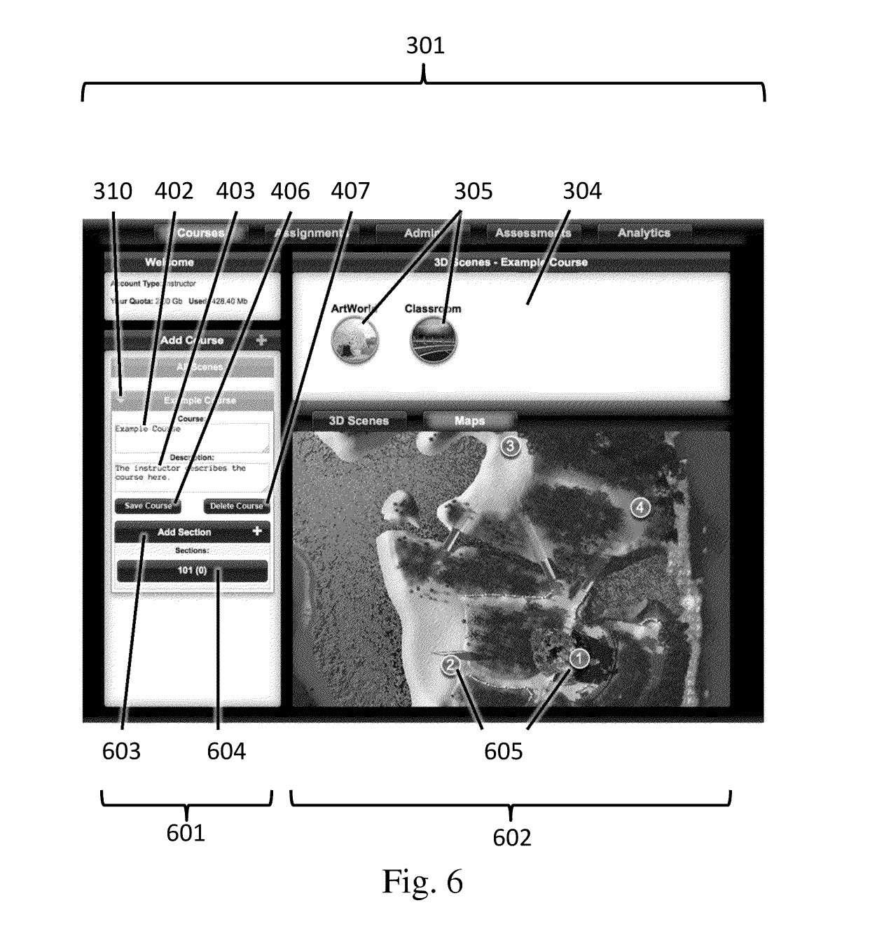

In the embodiment of FIG. 3, in-use 3D scenes display area 304 contains 3D scene icons 305 representing 3D scenes that are made available by the CMS to the user for creating and displaying presentations. In the embodiment of FIG. 3, each 3D scene icon 305 in in-use 3D scenes display area 304 represents a virtual 3D environment for which data for a presentation has been stored in the CMS. In the embodiment of FIG. 3, available 3D scenes display area 306 displays 3D scene icons 305 for scenes that may or may not currently have presentations associated with them in the CMS database but that are available for association with presentations. It is to be noted that in the embodiment of FIG. 3, if 3D scene icons 305 have presentations associated with them, these presentations remain attached whether the icon is located in in-use 3D scene display area 304 or in available 3D scenes display area 306. In the embodiment of FIG. 3, one or more 3D scene icons 305 may be dragged from available 3D scenes display area 306 and dropped into in-use 3D scenes display area 304 by clicking and dragging with a mouse or other cursor control device. In the embodiment of FIG. 3, one or more 3D scene icons 305 may be dragged from in-use 3D scenes display area 304 and dropped into available 3D scenes display area 306. In the embodiment of FIG. 3, 3D scene icons 305 may be dragged and dropped within in-use 3D scenes display area 304 or available 3D scenes display area 306 to change the order in which 3D scene icons 305 are displayed. In the embodiment of FIG. 3, the user may click on a 3D scene icon 305 shown in in-use 3D scenes display area 304 with a mouse button or other cursor control device to display an overhead view of the scene, as shown and described below in connection with FIG. 6. In one or more embodiments, a set of 3D scenes may be provided by the 3-D virtual world server system with which the CMS system is configured to interact. In one or more embodiments, a user may create his or her own 3D scenes.

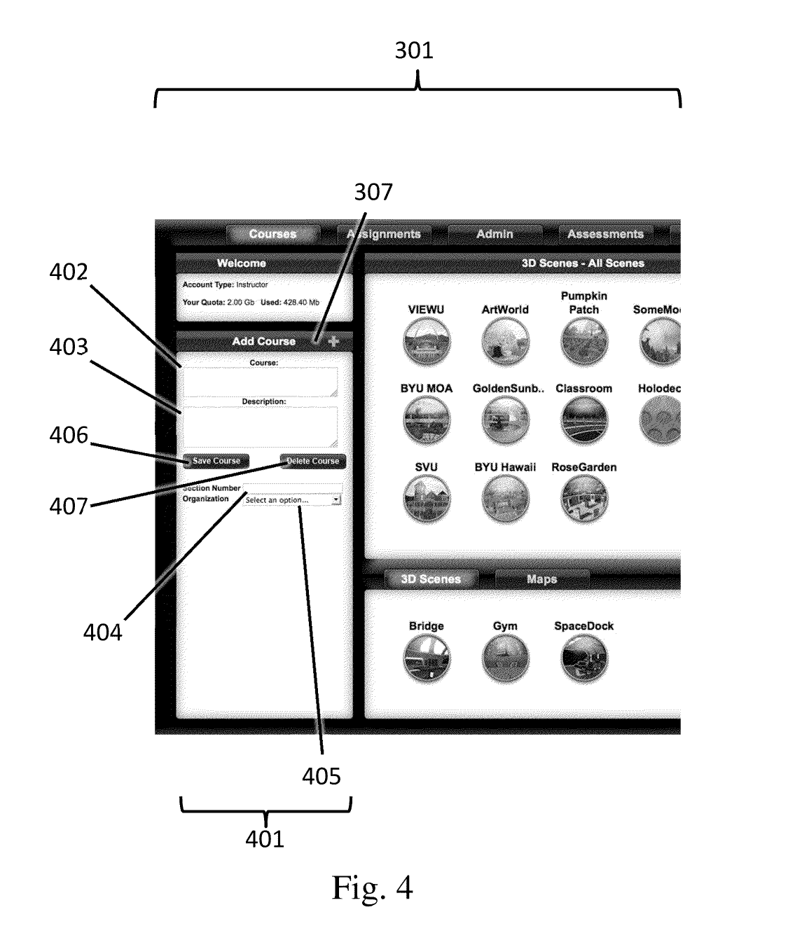

In the embodiment of FIG. 3, Add Course control button 307 provides an interface for the user to create new course data to be stored in the CMS database, as discussed in connection with FIG. 4 below. In the embodiment of FIG. 3, list of courses 308 displays a list of all the courses 309 for which data has been associated by the CMS with a user account. In the embodiment of FIG. 3, activation of expansion control button 310 causes the CMS to display and edit course information, as discussed in connection with FIG. 6 below.

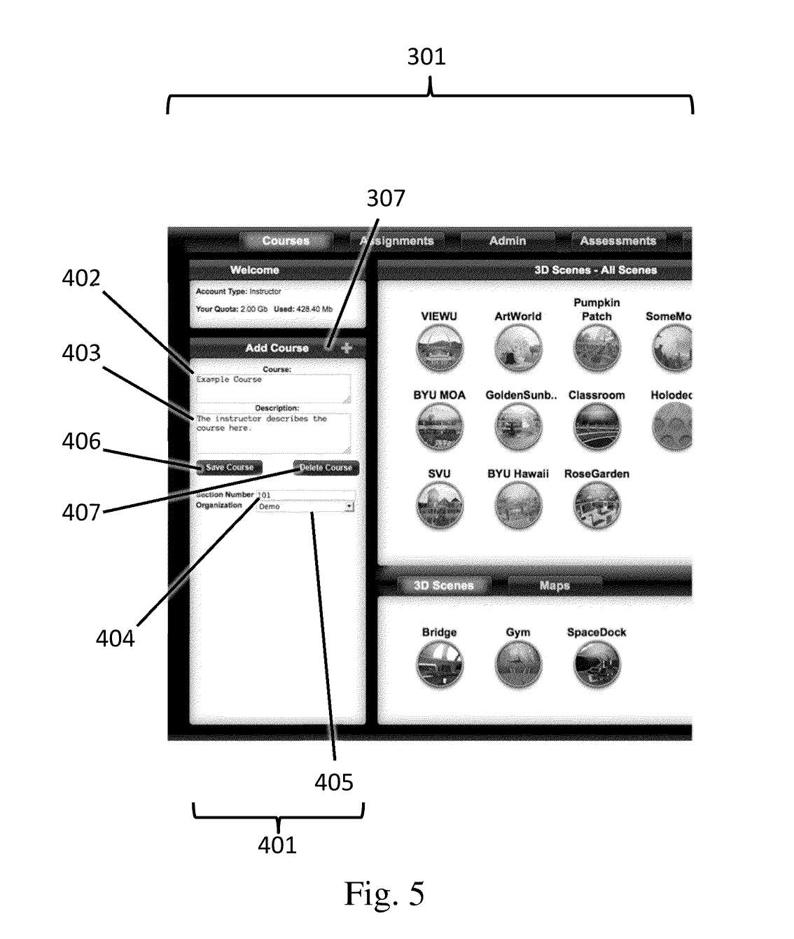

FIGS. 4 and 5 show add course interface 401 of course management user interface 301, which the CMS transmits to the user's computer or other internet access device when Add Course control button 307 is activated. In the embodiment of FIG. 4, add course interface 401 provides Course text field 402, Description text field 403, Section Number field 404, Organization drop-down box 405, Save Course control button 406, and Delete Course control button 407. In the embodiment of FIG. 4, Course text field 402 provides a text entry field to receive the name of the course, e.g. “English Literature”. In the embodiment of FIG. 4, Description text field 403 provides a text entry field to receive a more detailed description of the course. In the embodiment of FIG. 4, Section Number field 404 provides a text entry field to receive a section number. In one or more embodiments, the CMS provides the capability of associating a single course with one or more sections. In one or more embodiments, the CMS provides the capability of associating each section with a particular group of students, and for specifying one or more times or time periods associated a class. The time period may for example identify a periodic time period during which students are expected to access the 3-D virtual environment associated with the class. For example, a first section might have associated with it the times of Mondays and Wednesdays at 10 AM, while a second section might have associated with it the times of Tuesdays and Thursdays at 2 PM. In one or more embodiments, the CMS treats each course as a data object, and each section as a separate instance of the course data object. In the embodiment of FIG. 4, Organization drop-down list box 405 provides a control for associating an organization, institution, or branch of an organization or institution to with a course in the CMS database. For example, an instructor who has an instructor account with the CMS may teach courses at several different institutions. Organization drop-down list box 405 provides the capability for the instructor to associate different sections of a course with those different institutions in the CMS database. Alternatively, in one or more embodiments, the organization database entry may be used to distinguish different campuses of the same university, or different affiliated universities, e.g. an engineering college and a liberal arts college that offer courses to each others' students. In the embodiment of FIG. 4, activation of Save Course control button 406 causes the information entered into Course text field 402, Description text field 403, and Organization drop-down box 405 to be transmitted to the CMS and stored by the CMS in the CMS database. In the embodiment of FIG. 4, activation of Save Course control button 406 causes a new section having the name entered in Section Number field 404 to be created in the database by the CMS and linked with a course displayed in add course interface 401. In the embodiment of FIG. 4, activating Delete Course control button 407 causes the CMS to delete the course displayed in add course interface 401 from the database, including any and all sections linked to the course. In the embodiment of FIG. 4, activation of either Save Course control button 406 or Delete Course control button 407 causes add course interface 401 to be replaced by the CMS with course management user interface 301, shown in FIG. 3.

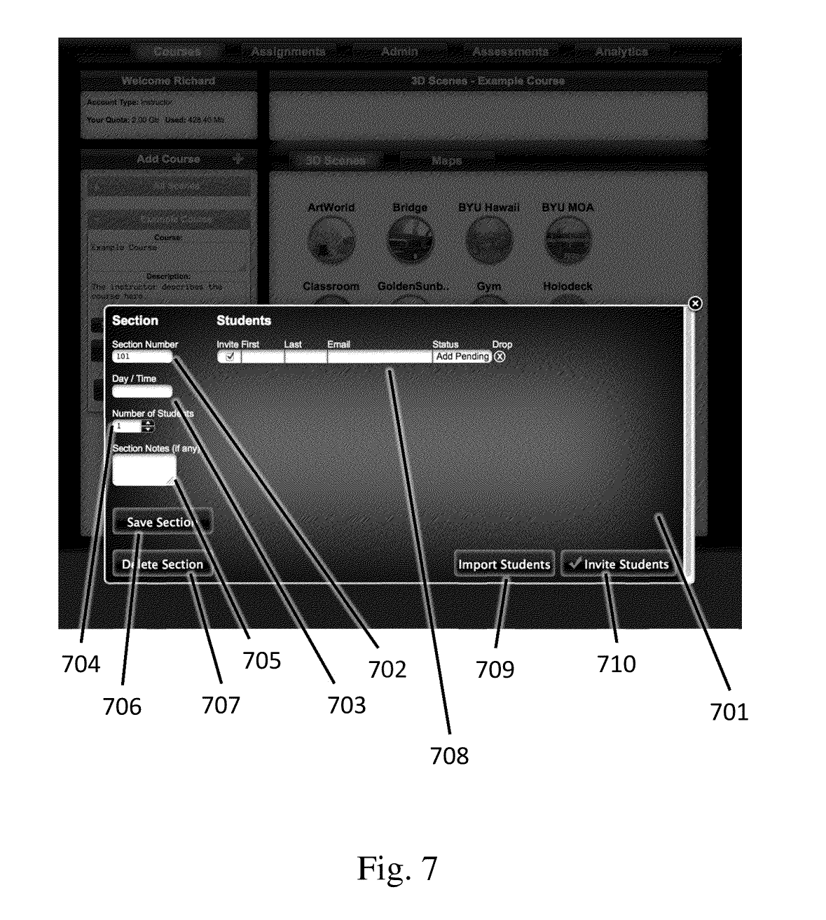

FIG. 6 shows edit course user interface 601 and overhead scene view 602 of course management user interface 301 that the CMS transmits to the user's computer or other internet access device in one or more embodiments. In the embodiment of FIG. 6, activation of expansion control button 310 causes course information to be displayed in edit course user interface 601. In the embodiment of FIG. 6, Course text field 402, Description text field 403, Save Course control button 406, and Delete Course control button 407 function as described above in connection with FIGS. 4 and 5. In the embodiment of FIG. 6, activation of Add Section control button 603 causes the CMS to create a new blank section and to send section user interface 701 to the user's computer or other internet access device. In the embodiment of FIG. 6, activation of a Section control button 604 causes the CMS to send section user interface 701 to the user's computer or other internet access device. The function of section user interface 701 is discussed in greater detail in connection with FIG. 7 below.

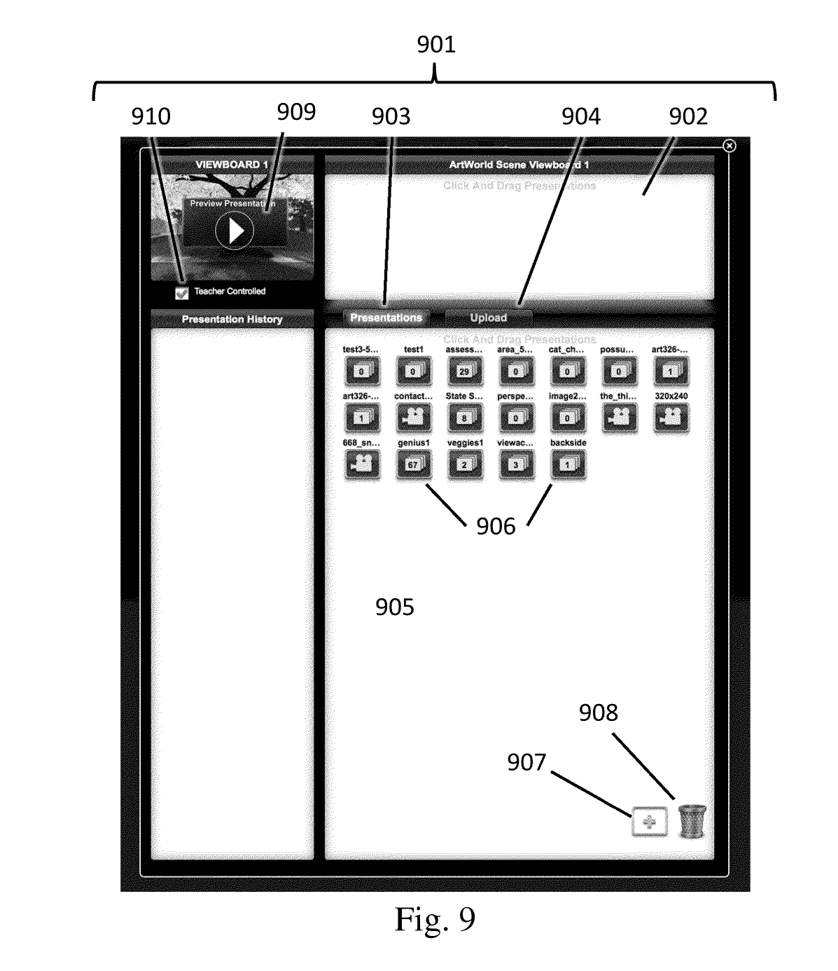

In the embodiment of FIG. 6, selecting a 3D scene icon 305 from in-use 3D scenes display area 304 (e.g. by clicking on the icon with a mouse button) causes the CMS to display overhead scene view 602 in the bottom-right region of course management user interface 301. In one or more embodiments, overhead scene view 602 represents a top-down map view of the selected 3D scene with VIEWBoard™ markers 605. In one or more embodiments, each VIEWBoard™ marker 605 represents a location of a pre-existing VIEWBoard™ in the 3D virtual world. “VIEWBoard™” is a trademark of applicant for a facility in a 3D world on which a presentation may be displayed. Examples of VIEWBoards™ include 3D representations of display screen, blackboards, video monitors, etc. In one or more embodiments, selecting a VIEWBoard™ marker 605 causes the CMS to transmit presentation editing user interface 901 to the user's computer or other internet access device, as discussed in greater detail in connection with FIG. 9 below.

FIG. 7 shows section user interface 701 that the CMS transmits to the user's computer or other internet access device in one or more embodiments. In the embodiment of FIG. 7, section interface 701 has Section Number field 702, Day/Time field 703, Number of Students field 704, Section Notes text field 705, Save Section control button 706, Delete Section control button 707, student list 708, Import Students control button 709, and Invite Students control button 710. In the embodiment of FIG. 7, Section Number field 702 provides a text entry field for receiving the section number, e.g. “101”. In the embodiment of FIG. 7, Day/Time field 703 provides a text entry field for receiving the day and time a section is scheduled, e.g. “MW 10 a” for Mondays and Wednesdays at 10 AM. In the embodiment of FIG. 7, Number of Students field 704 comprises a drop down list that allows the user to select the number of students enrolled in the section. In one or more embodiments, the number of entries in student list 708 equals the number shown in Number of Students field 704, so selecting a higher number from the Number of Students drop down list 704 causes rows to be added to student list 708 and selecting a lower number inform the Number of Students drop down list 704 causes rows to be deleted from student list 708. In the embodiment of FIG. 7, Section Notes text field 705 provides a text entry field for receiving notes for the section from the instructor. In one or more embodiments, section notes are displayed by the CMS only to students enrolled in the section. In one or more embodiments, section notes are displayed by the CMS only to the instructor.

In the embodiment of FIG. 7, activation of Save Section control button 706 causes the CMS to store the information entered into Section Number field 702, Day/Time field 703, Number of Students field 704, Section Notes text field 705, and student list 708 in the CMS database. In the embodiment of FIG. 7, activation of Delete Section control button 707 causes the CMS to delete the section displayed in section interface 701 from the database. In the embodiment of FIG. 7, activation of either Save Section control button 706 or Delete Section control button 707 causes the CMS to replace section interface 701 with edit course interface 601, discussed above in connection with FIG. 6.

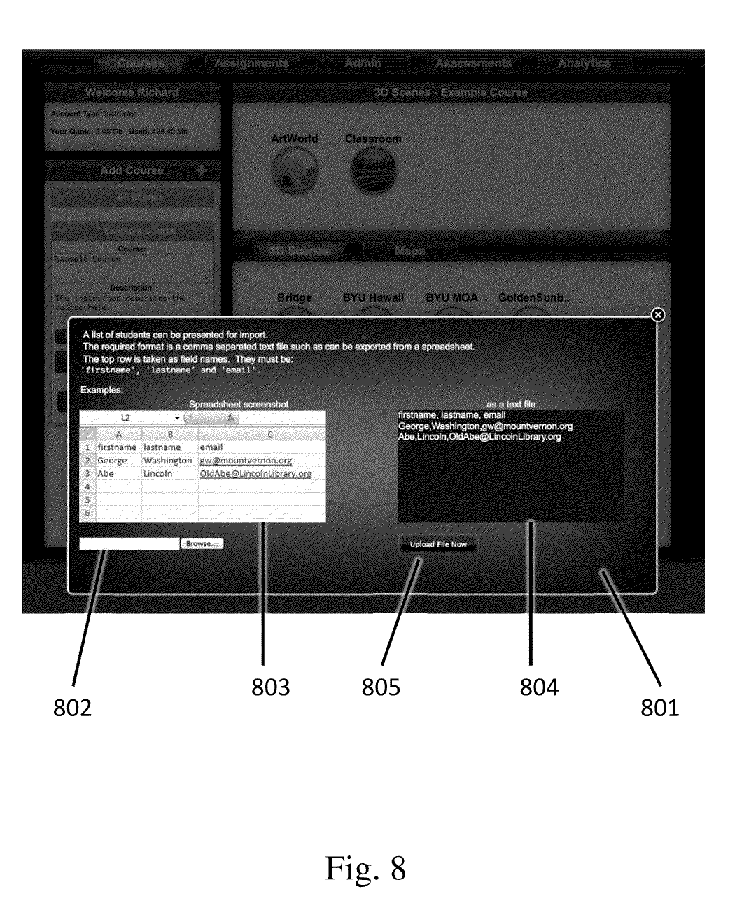

In the embodiment of FIG. 7, student list 708 is a list of students enrolled in the section. In the embodiment of FIG. 7, student list 708 includes text fields for the student's first name, last name, and email address, along with an “invite” checkbox and a status display. In the embodiment of FIG. 7, activation of Invite Students control button 710 causes the CMS to send an email to the email address of each student in student list 708 that has the “invite” checkbox selected. In one or more embodiments, the email sent to each student contains a hyperlink back to the CMS server so that by selecting the link, the CMS identifies the student as being enrolled in the class in the CMS database. In the embodiment of FIG. 7, the status display for each student shows whether the student has been sent an invitation and whether that invitation has been accepted. In the embodiment of FIG. 7, Import Students control button 709 causes the CMS to transmit import students user interface 801 to the user's computer or other internet access device, as shown and described in connection with FIG. 8 below.

FIG. 8 shows import students user interface 801 that the CMS transmits to the user's computer or other internet access device in one or more embodiments. In the embodiment of FIG. 8, import students user interface 801 includes file selection field 802, spreadsheet screenshot 803, text file example 804, and Upload File control button 805. In the embodiment of FIG. 8, file selection field 802 provides a text entry field for the user to specify a file, stored on the user's computer, that contains a list of student names and email addresses for uploading to the CMS. In the embodiment of FIG. 8, spreadsheet screenshot 803 displays an example of a spreadsheet with three columns: first name, last name, and email address. In the embodiment of FIG. 8, text file example 804 shows the same three columns in the form of a comma-separated value (“CSV”) text file. In one or more embodiments, the file specified in file selection field 802 must be in the CSV format shown in figure text file example 804 to be operated upon by the CMS. In one or more embodiments, the file specified in file selection field 802 may be in another format, such as a Microsoft Excel spreadsheet. In the embodiment of FIG. 8, Upload File control button 805 causes the file specified in file selection field 802 to be uploaded to the CMS. After receipt, the CMS stores the data contained therein in its database and uses the data to update the fields of student list 708.

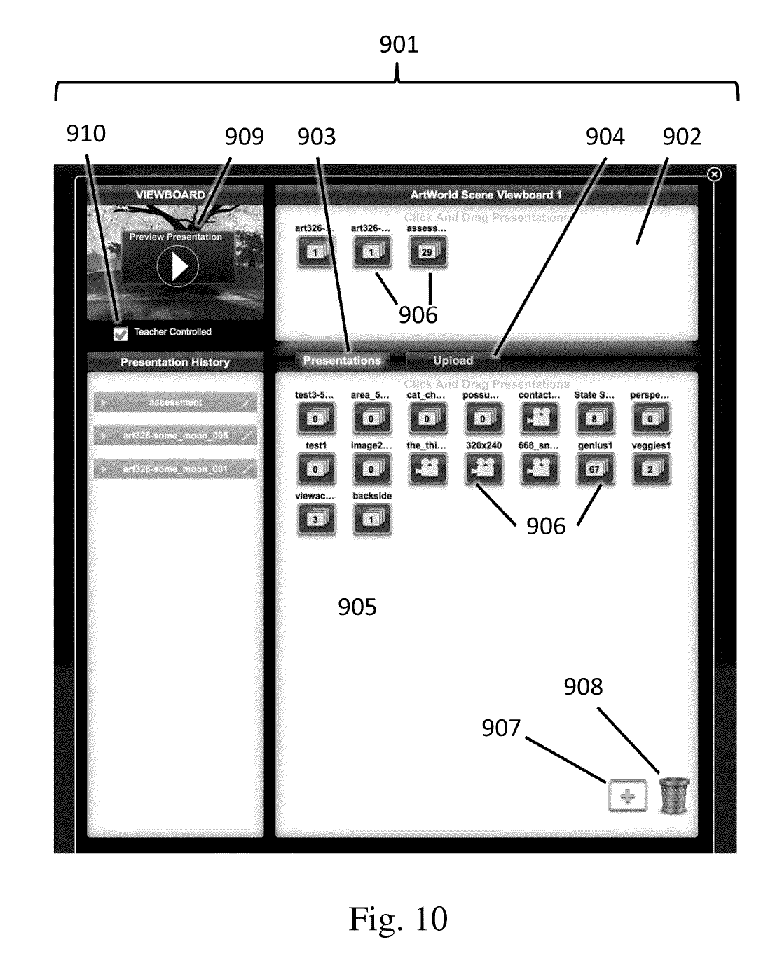

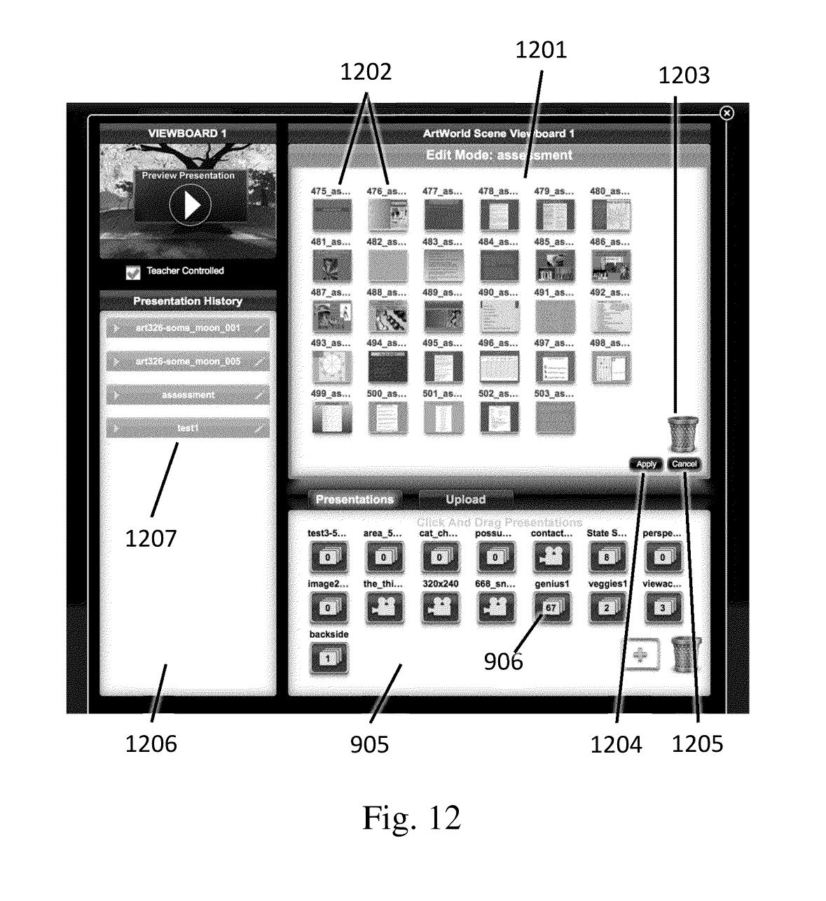

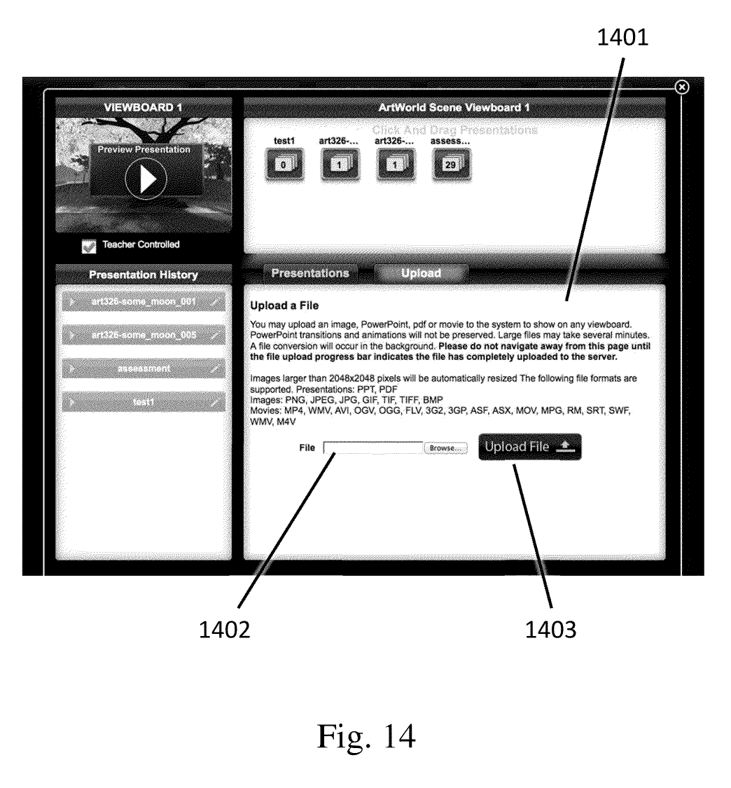

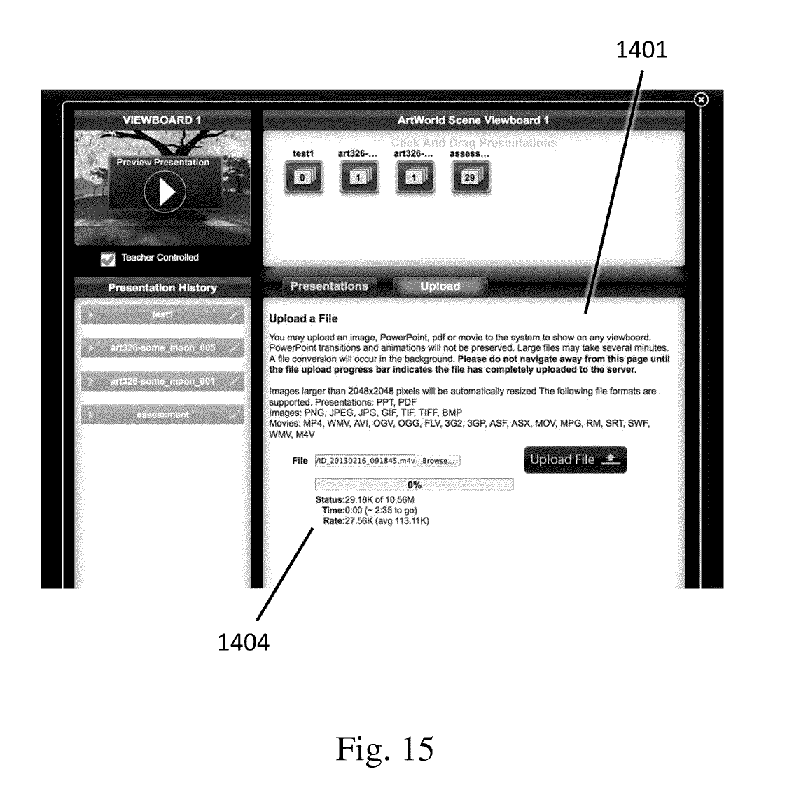

FIGS. 9 and 10 show VIEWBoard™ editing user interface 901 that the CMS transmits to the user's computer or other internet access device in one or more embodiments. In the embodiment of FIGS. 9 and 10, VIEWBoard™ editing user interface 901 includes VIEWBoard™ presentation display area 902, Presentations tab 903, Upload tab 904, available presentations display area 905 containing icons representing uploaded presentations 906, New Presentation control button 907, Trash icon 908, Preview Presentation control button 909, and Teacher Controlled checkbox 910. In the embodiment of FIGS. 9 and 10, VIEWBoard™ presentation display area 902 displays icons representing presentations 906 that have been stored in the CMS database and that may be associated with a VIEWBoard™ in a 3D virtual world. In the embodiment of FIGS. 9 and 10, selecting Presentations tab 903 displays available presentations display area 905. In the embodiment of FIGS. 9 and 10, selecting Upload tab 904 displays upload user interface 1401, more fully described in connection with FIGS. 14 and 15 below. In the embodiment of FIGS. 9 and 10, available presentations display area 905 shows icons 906 representing presentations that have been uploaded to the CMS database or that have been created using VIEWBoard™ editing user interface 901, but which may or may not have not been associated by the CMS with any particular VIEWBoard™ of a 3D virtual world. In one or more embodiments, icons 906 may represent presentations that consist of individual images, collections of images (e.g. images of slides from a PowerPoint presentation), or individual videos. In one or more embodiments, the CMS stores information about each presentation represented by each icon 906 in its database, including the location of the image or video data for the presentation, any VIEWBoard™ the presentation is associated with, and whether an icon representing the presentation appears in VIEWBoard™ presentation display area 902 or in available presentations display area 905. In the embodiment of FIGS. 9 and 10, double-clicking on an icon 906 causes the CMS to transmit presentation editing user interface 1201 to the user's computer or other internet access device, as discussed below in connection with FIG. 12.

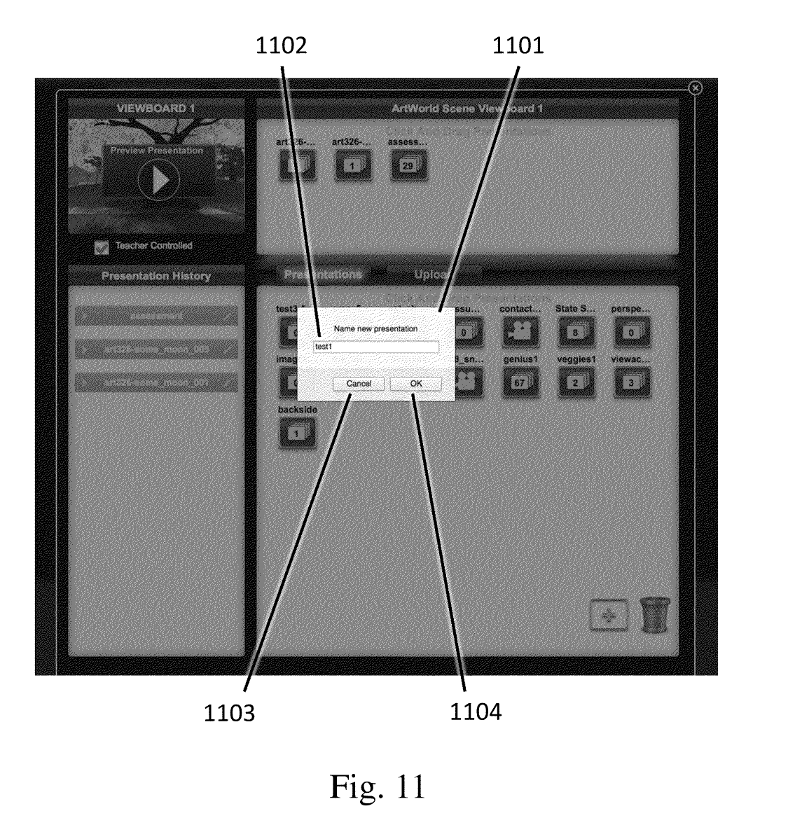

In the embodiment of FIGS. 9 and 10, icons 906 may be dragged from available presentations display area 905 and dropped into VIEWBoard™ presentation display area 902 to select the presentations represented by icons 906 for display on the VIEWBoard™ identified in the title block for VIEWBoard™ presentation display area 902. In the embodiment of FIGS. 9 and 10, icons 906 may be dragged and dropped to change the order that the presentations represented by icons 906 will be displayed on the VIEWBoard™. In the embodiment of FIGS. 9 and 10, icons 906 may be dragged from VIEWBoard™ presentation display area 902 and dropped into available presentations display area 905 to remove those presentations represented by icons 906 from the set of presentations that will be displayed on that VIEWBoard™. In the embodiment of FIGS. 9 and 10, New Presentation control button 907 causes the CMS to transmit new presentation user interface 1101 to the user's computer or other internet access device, as further described in connection with FIG. 11 below. In the embodiment of FIGS. 9 and 10, icons 906 may be dragged from available presentations display area 905 and dropped onto Trash icon 908 to delete those presentations represented by those icons 906 from the CMS database. In the embodiment of FIGS. 9 and 10, Preview Presentation control button 909 launches the user's 3D virtual world environment access program and places the user in front of the VIEWBoard™, such that the user can play back the presentations represented by icons 906 in VIEWBoard™ presentation display area 902. In the embodiment of FIGS. 9 and 10, Teacher Controlled checkbox 910 selects whether the presentation is displayed synchronously (teacher-controlled) or asynchronously (student-controlled). In one or more embodiments, the synchronous mode allows the instructor to play back the presentation in real time to other users of the 3D virtual world, e.g. during a scheduled class lecture. In one or more embodiments, the asynchronous mode allows students to play back the presentation for themselves at any time, e.g. while studying outside of the scheduled lecture time.

FIG. 11 shows new presentation user interface 1101 that the CMS transmits to the user's computer or other internet access device in one or more embodiments. In the embodiment of FIG. 11, new presentation user interface 1101 has text entry field 1102, Cancel control button 1103, and OK control button 1104. In the embodiment of FIG. 11, text entry field 1102 provides a text entry field for receiving the name of the new presentation. In the embodiment of FIG. 11, OK control button 1104 causes the CMS to create a new presentation information entry in its database and display an icon for the in new presentation in available presentations display area 905. In the embodiment of FIG. 11, activating Cancel control button 1103 or OK control button 1104 causes the CMS to replace new presentation user interface 1101 to with VIEWBoard™ editing user interface 901 discussed above in connection with FIGS. 9 and 10. In one or more embodiments, newly created presentations created by the CMS are blank and have no stored data associated with them.

FIG. 12 shows presentation editing user interface 1201 that the CMS transmits to the user's computer or other internet access device in one or more embodiments when an icon 906 has been selected for editing, for example by double-clicking. In the embodiment of FIG. 12, presentation editing user interface 1201 displays thumbnails 1202 representing the set of individual images (e.g. slides) and/or videos contained in a presentation that has been uploaded to the CMS. In one or more embodiments, the CMS generates separate images of each page/slide of an uploaded presentation. For example, if an uploaded presentation is a Power Point presentation, the CMS generates an image of each page of the presentation. In one or more embodiments, the CMS performs such a conversion using a two step process, first converting the Power Point presentation into a pdf file, thereafter converting each page of the pdf file into a png image file.

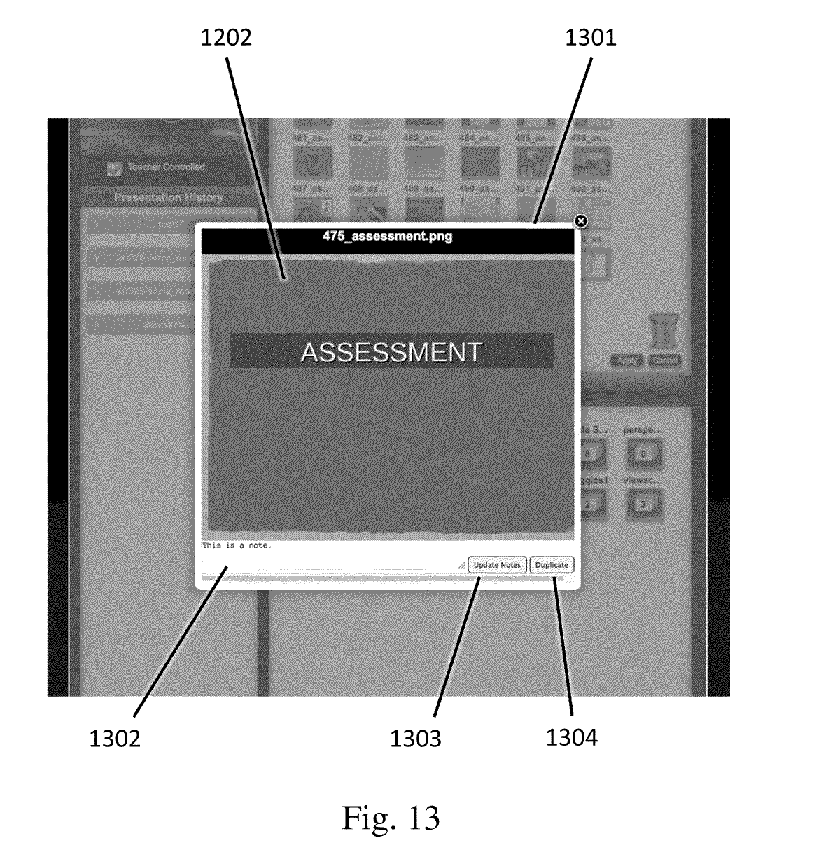

In the embodiment of FIG. 12, thumbnails 1202 may be dragged and dropped to change the order that the images represented by thumbnails 1202 will be displayed in the presentation represented by the selected icon 906. In the embodiment of FIG. 12, thumbnails 1202 may be clicked to open image preview user interface 1301, as shown and described below in connection with FIG. 13 below. In the embodiment of FIG. 12, thumbnails 1202 may be dragged and dropped onto Trash icon 1203 to delete those images represented by those thumbnails 1202 from the presentation represented by icon 906 and from the CMS database. In the embodiment of FIG. 12, a thumbnail 1202 may be dragged onto an icon 906 in available presentations area 905 to add the image or video represented by icon 1202 to that icon 906. In the embodiment of FIG. 12, activating Apply control button 1204 causes the changes made to the presentation represented by selected icon 906 to be stored in the CMS database. In the embodiment of FIG. 12, activating Cancel control button 1205 causes the changes made to the presentation represented by selected icon 906 to be discarded by not changing the CMS database. In the embodiment of FIG. 12, activating Apply control button 1204 or Cancel control button 1205 causes the CMS to replace presentation editing user interface 1201 with VIEWBoard™ editing user interface 901, discussed above in connection with FIGS. 9 and 10.

Edit presentation user interface 1201 of FIG. 12 also includes a presentation history area 1206 that contains presentation selection buttons 1207 for presentations that have been previously selected for editing, including the currently selected presentation. In the embodiment of FIG. 12, each presentation selection button 1207 contains the name of the presentation represented by that presentation selection button 1207. In one or more embodiments, presentation selection buttons 1207 are arranged in chronological order. In one or more embodiments, presentation selection buttons 1207 are arranged in alphabetical order. In one or more embodiments, selecting a presentation selection button 1207 causes the CMS to transmit a user interface to the user's computer or other internet access device that allows the user to rename or duplicate the presentation represented by that presentation selection button 1207.

FIG. 13 shows image preview user interface 1301 that the CMS transmits to the user's computer or other internet access device in one or more embodiments. In the embodiment of FIG. 13, image preview user interface 1301 displays an image represented by a selected thumbnail 1202. In the embodiment of FIG. 13, notes text field 1302 provides a text entry field for receiving notes from the user to be associated with the image or video represented by thumbnail 1202. In one or more embodiments, the CMS makes notes visible to students enrolled in the section for which the notes have been stored in the CMS database. In one or more embodiments, the CMS makes notes visible only to the instructor. In the embodiment of FIG. 13, Update Notes control button 1303 causes the CMS to store the contents of notes text field 1302 in the CMS database associated with the image represented by thumbnail 1202. In the embodiment of FIG. 13, activation of Duplicate control button 1304 causes the CMS to make a duplicate copy of image 1202 and store the copy in association with the presentation being edited in the CMS database.

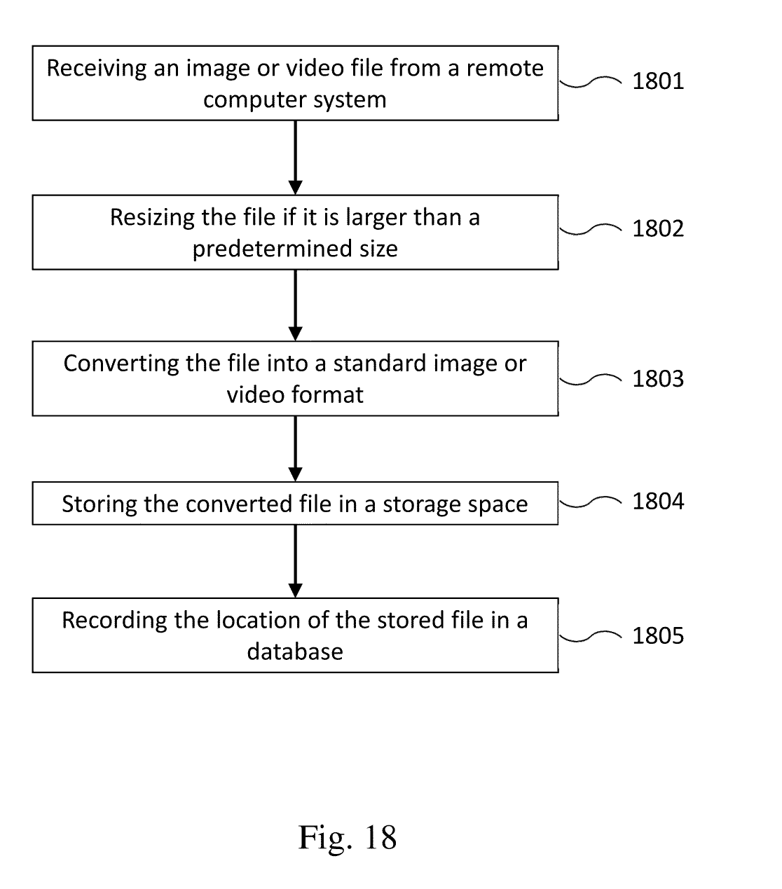

FIGS. 14 and 15 show upload user interface 1401 that the CMS transmits to the user's computer or other internet access device in one or more embodiments. In the embodiment of FIGS. 14 and 15, upload user interface 1401 includes file selection field 1402 and Upload File control button 1403. In the embodiment of FIG. 14, file selection field 1402 provides a text entry field for receiving information identifying a file stored on the user's computer. In the embodiment of FIG. 14, Upload File control button 1403 causes the user's computer to upload the selected file to the CMS for storage. In the embodiment of FIG. 15, progress information 1404 is provided by the CMS to the user's computer or other internet access device while the file is uploaded. In the embodiment of FIG. 15, progress information 1404 indicates the percentage of the file transfer that has completed, the amount of data uploaded, the total file size, time elapsed, estimated time remaining, instantaneous upload rate, and average upload rate. In the embodiment of FIG. 15, once the file upload completes, the user's computer or other internet display device displays presentations display area 905 (discussed above in connection with FIG. 9) so that the user can see that the file was uploaded and begin using the uploaded file in one or more presentations. In one or more embodiments, the CMS accepts common image file formats such as PNG, JPEG, GIF, TIFF, BMP, common presentation file formats such as Power Point presentations and pdf files, and common video formats such as MPEG 1/2/4, Windows Media Video, AVI, Ogg video, Flash video, 3G video, Quicktime video, and RealMedia. In one or more embodiments, the CMS accepts any image or video format known in the prior art. In one or more embodiments, the CMS converts the uploaded file into a standard format, as shown and described below in connection with FIG. 18.

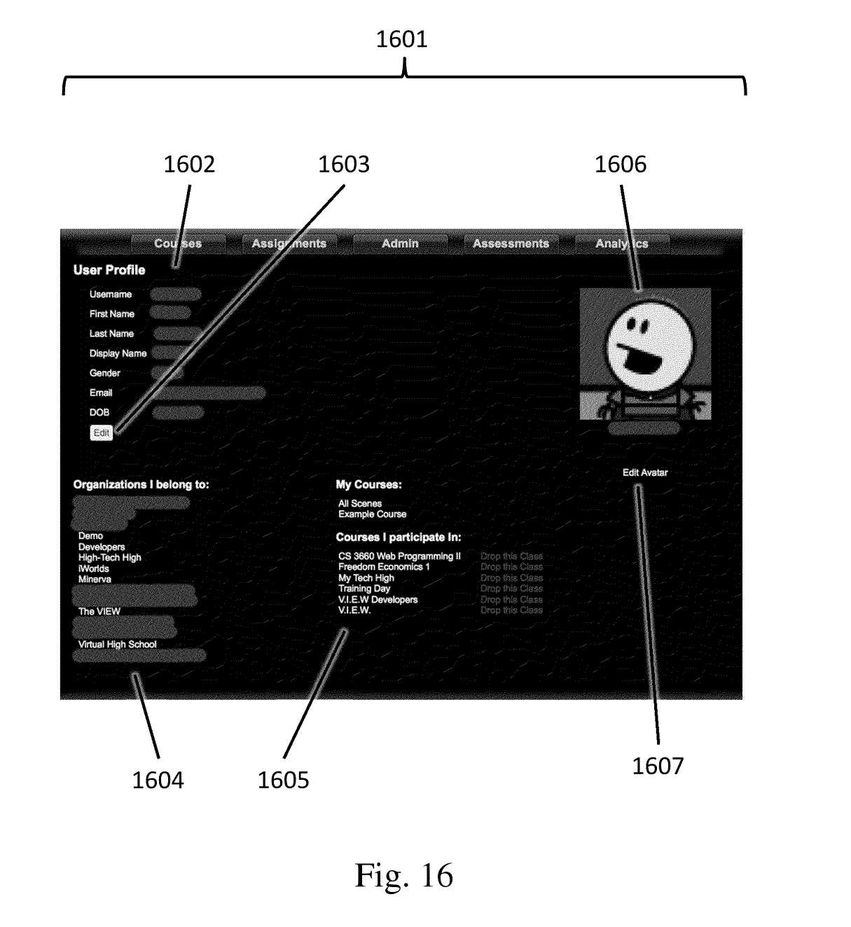

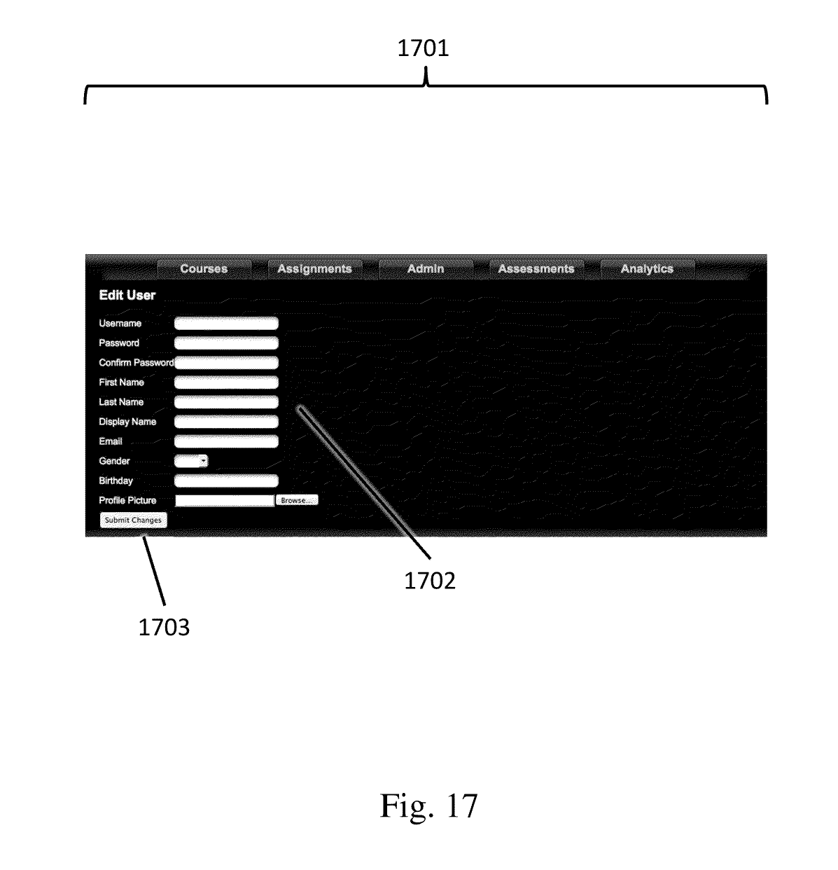

FIG. 16 shows user profile user interface 1601 that the CMS transmits to the user's computer or other internet access device in one or more embodiments. In the embodiment of FIG. 16, user profile user interface 1601 displays user profile information 1602, Edit control button 1603, organization list 1604, courses list 1605, avatar picture 1606, and Edit Avatar control button 1607. In the embodiment of FIG. 16, user profile information 1602 includes a user's user (login) name, first name, last name, display name (e.g., a nickname), gender, email address, and date of birth. In the embodiment of FIG. 16, activation of Edit control button 1603 causes “edit user” user interface 1701 to be transmitted by the CMS to the user's computer or other internet access device, discussed in connection with FIG. 17 below. In the embodiment of FIG. 16, organization list 1604 displays a list of organizations the user account is associated with in the CMS database, such as universities, research institutes, or companies. In the embodiment of FIG. 16, courses list 1605 displays the courses associated with the user account in the CMS database, including “My Courses” (if the user account is an instructor account and the instructor is teaching classes) and “Courses I participate in”. In the embodiment of FIG. 16, avatar picture 1606 displays a picture associated with the user account in the CMS database. In the embodiment of FIG. 16, Edit Avatar control button 1607 causes the user's computer or other internet access device to launch an applicable 3D virtual world access program so that the user can edit their 3D character's appearance.

FIG. 17 shows edit user user interface 1701 that the CMS transmits to the user's computer or other internet access device in one or more embodiments. In the embodiment of FIG. 17, edit user user interface 1701 includes text fields 1702, which provide text entry fields for receiving new user profile information, including a new username, password, first name, last name, display name, email address, gender, birthday, or profile picture. In the embodiment of FIG. 17, activating Submit Changes control button 1703 causes the CMS to update its database with the new information entered in text fields 1702.

FIG. 18 illustrates a method for uploading, converting, and storing an image, presentation or video file used by one or more embodiments of the CMS. In the embodiment of FIG. 18, the method starts at step 1801. In step 1801, the CMS receives an image, presentation or video file from a remote computer system (e.g., the user's personal computer). From step 1801, the method continues to step 1802. In step 1802, the CMS reads the received image, presentation, or video file to determine whether the file is larger than a predetermined size. In accordance with at least one embodiment, image files are restricted to certain maximum dimensions, e.g. 2048×2048 pixels. In accordance with at least one embodiment, video files are restricted to a certain maximum data rate, e.g. 1000 kbit/sec. In accordance with at least one embodiment, image and video files may be restricted to a certain maximum file size, e.g. 20 MB. In step 1802, the CMS resizes the image, presentation or video file to the maximum allowed size if it is too large. From step 1802, the method continues to step 1803. In step 1803, the CMS converts the image, presentation or video file into a standard format for use by the 3D virtual world. In accordance with at least one embodiment, images are converted to PNG format. In accordance with at least one embodiment, each page of a presentation is converted into a PNG format image. In accordance with at least one embodiment, a Power Point presentation is first converted into pdf format, then each pdf page is converted into a PNG format image, using, for example, an open source conversion product such as Apache Open Office and the Apache Open Office API project. In accordance with at least one embodiment, videos are converted into Ogg video format. From step 1803, the method continues to step 1804. In step 1804, the converted file (or files in the case of a presentation converted into multiple image files) is stored in a storage space. In accordance with at least one embodiment, the storage space is a disk connected to the CMS. In accordance with at least one embodiment, the storage space is located on a remote computer system. In accordance with at least one embodiment, the storage space is Internet-based, e.g. Amazon's S3 service. From step 1804, the method continues to step 1805. In step 1805 the CMS records the location of the stored file in the CMS database.

Thus one or more embodiments of a content management system for a 3D virtual world has been disclosed. Although the present invention has been described with respect to certain specific embodiments, it will be clear to those skilled in the art that the inventive features of the present invention are applicable to other embodiments as well, all of which are intended to fall within the scope of the present invention. For example, the CMS can be implemented entirely on a single computer system, or its various components can be distributed among several computer systems. Further, the CMS might provide additional functionality, such as managing and tracking course assignments and grades, or providing an online test-taking system. Other variations of and uses for various aspects of the present invention will be apparent to those of skill in the art.

1. A content management system for managing presentation content for a 3D virtual environment comprising:
a server system configured to serve a plurality of user interfaces via a network to a plurality of user internet access devices;
a database system connected to said server system, said database system comprising data associated with a plurality scenes of said 3D virtual environment;
wherein said plurality of user interfaces comprises:
a first user interface configured to display visual data identifying a plurality of said scenes of said 3D virtual environment and to receive a command for selecting a selected scene of said plurality of available scenes;
a second user interface configured to display visual data identifying a plurality of display locations in said selected scene and to receive a command for selecting a selected display location of said plurality of display locations;
a third user interface configured to display visual data identifying a plurality of available presentation content items and to receive a command for selecting a selected presentation content item of said plurality of available presentation content items and associating said selected presentation content item with said selected display location;
and wherein said server system is further configured to store data associating said selected presentation content item with said selected display location in said database system.

2. The content management system of claim 1 wherein said plurality of user interfaces further comprises a fourth user interface configured to display visual data comprised by said selected presentation content item and to accept commands for editing said selected presentation content item.

3. The content management system of claim 2 wherein said visual data comprised by said selected presentation content item comprises an ordered set of visual data.

4. The content management system of claim 3 wherein said commands for editing said selected presentation content item include commands for changing an order of said ordered set of visual data.

5. The content management system of claim 3 wherein said ordered set of visual data comprises an ordered set of images.

6. The content management system of claim 3 wherein said ordered set of visual data comprises video data.

7. The content management system of claim 2 wherein said plurality of user interfaces comprises a fifth user interface configured to receive data identifying a presentation content item to be uploaded by said server system.

8. The content management system of claim 1 wherein said plurality of user interfaces comprises a sixth user interface configured to display visual data identifying an educational course for which data is stored in said database system.

9. The content management system of claim 8 wherein said sixth user interface is further configured to accept data identifying a new educational course.

10. The content management system of claim 9 wherein said server system is configured to store said data identifying a new educational course in said database system.

11. The content management system of claim 8 wherein said sixth user interface is configured to accept commands for associating said educational course with a first of said plurality of scenes.

12. The content management system of claim 7 wherein said server system is configured to convert an uploaded presentation content item to an ordered set of visual data.

13. The content management system of claim 12 wherein said uploaded presentation content data item comprises a slide show presentation and wherein said ordered set of visual data comprises an individual bitmap image corresponding to each slide of said slide show presentation.

14. The content management system of claim 1 wherein said plurality of user interfaces further comprises a seventh user interface configured to accept commands for limiting access to said selected presentation content item to a designated set of users.

15. The content management system of claim 14 wherein said designated set of users comprises users associated in said database system with an educational course.

16. The content management system of claim 1 wherein said plurality of user interfaces further comprises an eighth user interface configured to display said selected presentation content item as displayed at said selected display location.

17. The content management system of claim 1 wherein said server system is configured to serve a web page configured to comprise a plurality of said user interfaces.

18. The content management system of claim 14 wherein said plurality of user interfaces further comprises a ninth user interface configured to accept commands for limiting access to said selected presentation content item to a designated time period.

19. The content management system of claim 1 wherein said 3d virtual environment comprises an environment provided by said server system.

20. The content management system of claim 1 wherein said server system comprises a plurality of server computers.
